(19) United States
(12) Patent Application Publication
(10) Pub. No.: US 2026/0280341 A1
(43) Pub. Date: Sep. 17, 2026

(54) RELAY PROTECTION EXTERNAL OPERATION INFORMATION INTELLIGENT MANAGEMENT SYSTEM AND METHOD

(71) Applicants: YUNNAN POWER GRID CO., LTD, Kunming (CN); YUNNAN ELECTRIC POWER TEST AND RESEARCH INSTITUTE (GROUP) CO., LTD, Kunming (CN)

(72) Inventors: Yuanhang YANG, Kunming (CN); Jiong CHEN, Kunming (CN); Qiaowei YANG, Kunming (CN); Jing CHEN, Kunming (CN); Yinyin LI, Kunming (CN); Xiao ZHANG, Kunming (CN); Hengchu SHI, Kunming (CN); Hao YOU, Kunming (CN); Yigong XIE, Kunming (CN); Benyu LI, Kunming (CN); Ming ZHAO, Kunming (CN); Xianping ZHAO, Kunming (CN); Xiaofan CHEN, Kunming (CN); Xiao HU, Kunming (CN); Yunkun DENG, Kunming (CN); Kao ZHOU, Kunming (CN); Wenjie GUO, Kunming (CN); Zicheng WANG, Kunming (CN); Xinchen LU, Kunming (CN); Hui LI, Kunming (CN); Wenyu LIU, Kunming (CN); Yurong LEI, Kunming (CN); Jie LI, Kunming (CN); Jianyu ZHOU, Kunming (CN); Zhihua HUANG, Kunming (CN); Guowu ZHANG, Kunming (CN); Ruijin LI, Kunming (CN); Zheng LIANG, Kunming (CN); Wenlin WANG, Kunming (CN); Wenhua YE, Kunming (CN)

(73) Assignees: YUNNAN POWER GRID CO., LTD, Kunming (CN); YUNNAN ELECTRIC POWER TEST AND RESEARCH INSTITUTE (GROUP) CO., LTD, Kunming (CN)

(21) Appl. No.: 19/644,169

(22) Filed: Apr. 10, 2026

Related U.S. Application Data
(63) Continuation of application No. PCT/CN2024/107221, filed on Jul. 24, 2024.

(30) Foreign Application Priority Data
Oct. 10, 2023 (CN) 202311300327.6

(51) Int. Cl. H02J 13/36; G06F 11/1446; H02J 13/10; H02J 13/12; H02J 13/13

(52) U.S. Cl. CPC H02J 13/36; G06F 11/1446; H02J 13/10; H02J 13/12; H02J 13/1321; H02J 13/1331

(57) ABSTRACT

An intelligent management system for relay protection external operation information includes: an input module, a data snapshot module, a data acquisition module, a data conversion module, a data storage module, a fault analysis module, a report generation module, an alarm signaling module, a real-time data analysis module, and a real-time data summoning module. The input module is connected to the data snapshot module. In response to receiving a whole-station accident general input, the input module sends a time stamp signal T1 to the data snapshot module. The data snapshot module snapshots relay protection external operation information data acquired by the data acquisition module during a time period from T1−T2 to T1+T2.

### CROSS-REFERENCE TO RELATED APPLICATIONS

This application is a continuation of International Application PCT/CN2024/107221, filed on Jul. 24, 2024, which claims priority to Chinese Patent Application No. 202311300327.6, filed on Oct. 10, 2023, the entire contents of which are incorporated herein by reference.

### TECHNICAL FIELD

The present application relates to the technical field of power grid data management, and in particular to a relay protection external operation information intelligent management system and method.

### BACKGROUND

Relay protection is a key component for ensuring safe and stable operation of a power system. Relay protection monitors an operating state of the power system and takes corresponding measures according to preset logic when a fault occurs, thereby preventing system loss and maintaining stable operation of a power grid. Existing specialized relay protection systems typically rely on a power grid relay protection and fault information system. The system serves as a link among protection devices, fault recorders, and a master station monitoring system, uploads relay protection information such as current, voltage, settings, and waveform records, and provides support for dispatchers after protection actions occur.

However, in addition to the relay protection information described above, relay protection devices are also associated with a large amount of external operation information, including a direct current system state, an equipment state in a station, and behavior information of on-site personnel. Such information also affects operation accuracy of the relay protection devices. In existing systems, this type of external operation information usually comes from different systems or devices, and acquisition methods are diverse, including wired transmission, wireless acquisition, and video monitoring. A unified communication and interaction mechanism among the data is lacking, making effective integration and sharing difficult.

Further, because some external operation information, such as video data, has a large data volume, a large amount of network bandwidth is occupied during transmission, which can easily increase system load. In related technologies, relay protection fault judgment mainly relies on information provided by a power grid relay protection and fault information system, and comprehensive use of the above external operation information is insufficient, which may affect accuracy of fault judgment.

Therefore, how to effectively acquire, process, and analyze relay protection external operation information to improve accuracy of fault judgment has become a technical problem to be solved.

### SUMMARY

The present application provides an intelligent management system for relay protection external operation information, including: an input module, a data snapshot module, a data acquisition module, a data conversion module, a data storage module, a fault analysis module, a report generation module, an alarm signaling module, a real-time data analysis module, and a real-time data summoning module.

In an embodiment, the input module is connected to the data snapshot module. In response to receiving a whole-station accident general input, the input module sends a time stamp signal T1 to the data snapshot module; T1 represents a time at which the input module receives the accident general input.

In an embodiment, the data snapshot module snapshots relay protection external operation information data acquired by the data acquisition module during a time period from T1−T2 to T1+T2; T2 represents a data snapshot delay, T2 is set to Tmax, and Tmax is a longest setting time of a protection action in a station.

In an embodiment, the data acquisition module is connected to the data snapshot module, and the data acquisition module provides the data snapshot module with real-time relay protection external operation information data. The data acquisition module includes a wired data acquisition module, a wireless data acquisition module, a video image data calling module, and an analog quantity acquisition module. The wired data acquisition module acquires relay protection external operation information transmitted in the station through a 61850 communication protocol, including state data of a station service direct current system and an alternating current system. The wireless data acquisition module acquires relay protection external operation information that cannot be directly transmitted in a wired manner in a switchyard, including state data of terminal box cabinet doors, oil temperature gauges, winding temperature gauges, SF6 density relays, actual positions of circuit breakers, actual positions of energy storage springs, and temperature and humidity states in terminal boxes and mechanism boxes. The video image data calling module is connected to an on-site operation visual supervision system and a station video image monitoring system, and calls on-site operation videos and daily video image monitoring videos in the station. The analog quantity acquisition module is configured to acquire an operating current and a ground current in the station.

The present application also provides a method for intelligent management of relay protection external operation information. The method may include: receiving an accident general input signal when a fault occurs; snapshotting relay protection external operation information within a preset time period; acquiring real-time operation data; performing format conversion and/or compression processing on snapshot data and real-time data; storing relevant data; performing real-time analysis and fault analysis based on the data; and generating a report and/or issuing an alarm according to an analysis result.

Through the intelligent management system and method for relay protection external operation information of the present application, multi-source relay protection external operation information can be collaboratively managed, and support can be provided for fault analysis, abnormality monitoring, and operation auxiliary decision-making.

### BRIEF DESCRIPTION OF THE DRAWINGS

To more clearly illustrate the technical solutions of the embodiments of the present application, the drawings used in the description of the embodiments will be briefly introduced below. Obviously, the drawings described below are only some embodiments of the present application. For those skilled in the art, other drawings can be obtained based on these drawings without creative effort.

FIG. 1 is an overall flowchart of an intelligent management system for relay protection external operation information according to an embodiment of the present application.

FIG. 2 is a circuit diagram of a station single-bay accident general loop of the intelligent management system for relay protection external operation information according to an embodiment of the present application.

FIG. 3 is a schematic view of data acquisition of the intelligent management system for relay protection external operation information according to an embodiment of the present application.

FIG. 4 is a schematic view of data conversion of the intelligent management system for relay protection external operation information according to an embodiment of the present application.

FIG. 5 is an analysis diagram of relay protection external operation information before an accident in the intelligent management system for relay protection external operation information according to an embodiment of the present application.

FIG. 6 is an analysis diagram of relay protection external operation information after an accident in the intelligent management system for relay protection external operation information according to an embodiment of the present application.

### DETAILED DESCRIPTION OF THE EMBODIMENTS

The embodiments of the present application are described in detail below with reference to the accompanying drawings. The described embodiments are only some embodiments of the present application, rather than all embodiments. Other embodiments obtained by those skilled in the art based on the embodiments of the present application without creative effort shall fall within the protection scope of the present application.

Secondly, “an embodiment” or “embodiment” as used herein refers to a particular feature, structure, or characteristic that may be included in at least one implementation of the present application. The phrase “in an embodiment” appearing in different places in this specification does not necessarily refer to the same embodiment, and is not a separate or alternative embodiment mutually exclusive with other embodiments.

In the description of the present application, it should also be noted that orientation or positional relationships indicated by terms such as “upper”, “lower”, “inner”, and “outer” are based on the orientation or positional relationships shown in the drawings, and are used only for conveniently describing the present application and simplifying the description, rather than indicating or implying that a referenced device or element must have a particular orientation or be constructed and operated in a particular orientation. Therefore, these terms should not be construed as limiting the present application. In addition, the terms “first”, “second”, or “third” are used for descriptive purposes only, and should not be construed as indicating or implying relative importance.

Unless otherwise expressly specified and limited in the present application, the terms “mounted”, “connected”, and “coupled” should be understood broadly. For example, a connection may be a fixed connection, a detachable connection, or an integral connection; similarly, the connection may be a mechanical connection, an electrical connection, a direct connection, an indirect connection through an intermediate medium, or internal communication between two elements. Those skilled in the art may understand specific meanings of the above terms in the present application according to specific circumstances.

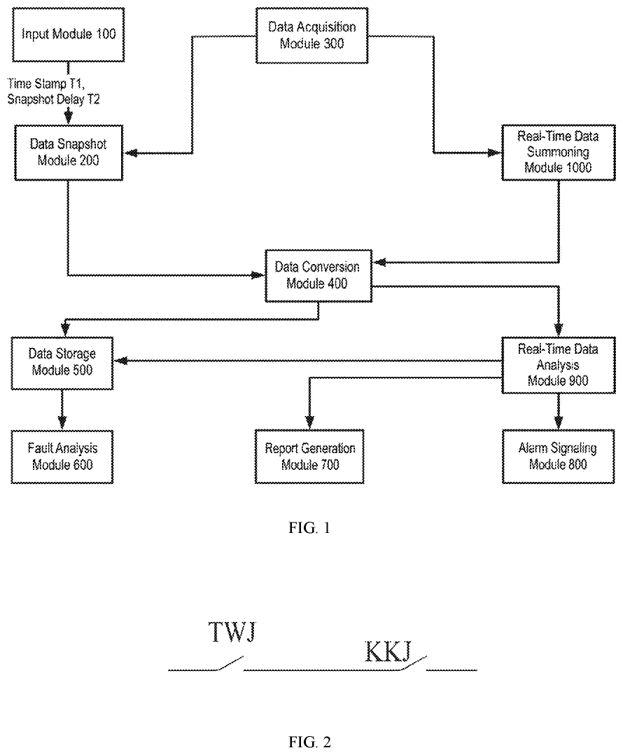

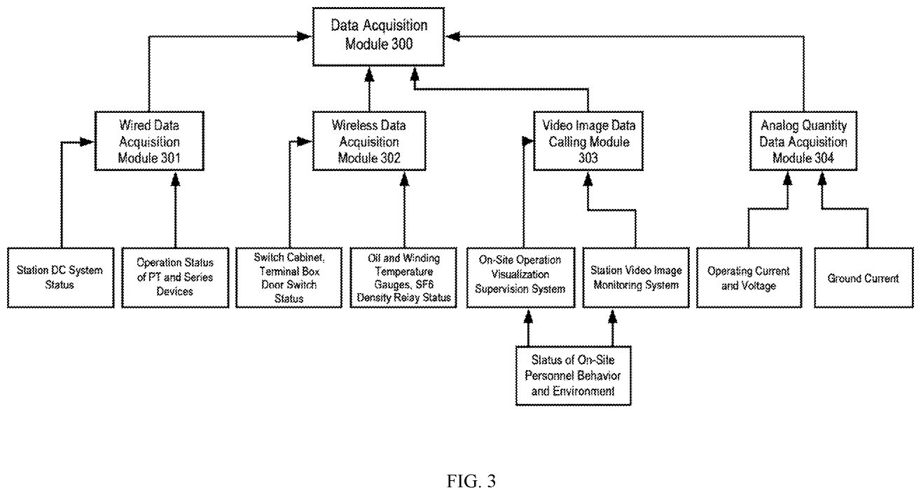

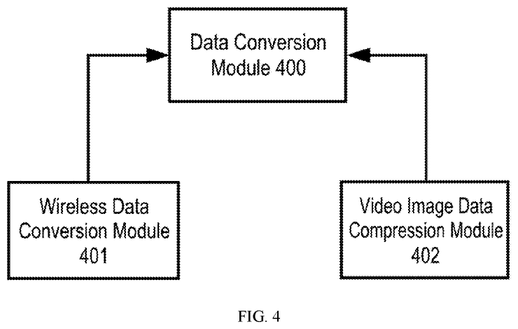

Referring to FIG. 1, in an embodiment of the present application, an intelligent management system for relay protection external operation information includes: an input module 100, a data snapshot module 200, a data acquisition module 300, a data conversion module 400, a data storage module 500, a fault analysis module 600, a report generation module 700, an alarm signaling module 800, a real-time data analysis module 900, and a real-time data summoning module 1000.

In an embodiment, the input module 100 may adapt to multiple transmission formats. The input module 100 is connected to the data snapshot module 200. In response to receiving a whole-station accident general input, the input module 100 sends a time stamp signal T1 to the data snapshot module 200; T1 represents a time at which the input module 100 receives the accident general input, and T1 is at a millisecond level. At the same time, other input information in the station may also be accessed and uploaded to a dispatcher through the input module, and the input information may be manually defined.

The data snapshot module 200 snapshots relay protection external operation information data acquired by the data acquisition module 300 during a time period from T1−T2 to T1+T2. T2 represents a data snapshot delay, T2 is set to Tmax, and Tmax is a longest setting time of a protection action in the station.

The data acquisition module 300 is connected to the data snapshot module 200, and the data acquisition module 300 provides the data snapshot module 200 with real-time relay protection external operation information data. The data acquisition module 300 includes a wired data acquisition module 301, a wireless data acquisition module 302, a video image data calling module 303, and an analog quantity acquisition module 304. The wired data acquisition module 301 acquires relay protection external operation information transmitted in the station through a 61850 communication protocol, including state data of a station service direct current system and an alternating current system. The wireless data acquisition module 302 acquires relay protection external operation information that cannot be directly transmitted in a wired manner in a switchyard, including state data of terminal box cabinet doors, oil temperature gauges, winding temperature gauges, SF6 density relays, actual positions of circuit breakers, actual positions of energy storage springs, and temperature and humidity states in terminal boxes and mechanism boxes. The video image data calling module 303 is connected to an on-site operation visual supervision system and a station video image monitoring system, and calls on-site operation videos and daily video image monitoring videos in the station. The analog quantity acquisition module mainly acquires an operating current and a ground current in the station, and mainly acquires a current of an N600 ground wire. N600 is a circuit number of a unique grounding point of a secondary voltage circuit in a substation. The wireless data acquisition module 302 uses a private-network data acquisition mode based on an MDS data transmission radio.

By using the wired data acquisition module 301, the wireless data acquisition module 302, the video image data calling module 303, and the analog quantity acquisition module 304 to access relay protection external operation information from different sources, multiple data interaction modes, including wired transmission, wireless transmission, and calling other systems, can be provided for the relay protection external operation information, thereby improving adaptability of the system to different information sources and different transmission modes.

In an embodiment, the wireless data acquisition module 302 is formed by a directional antenna, a data transmission radio, a remote terminal unit (RTU), and a small communication base station. The directional antenna includes a directional transmitting antenna and a directional receiving antenna. The directional transmitting antenna is characterized by increasing an effective utilization rate of radiated power and increasing confidentiality, and functions to transmit a specific wireless signal. The directional receiving antenna is characterized by enhancing signal strength and increasing anti-interference capability, and functions to receive a specific wireless signal.

The data transmission radio is connected to the small communication base station, and is a wireless data acquisition radio using digital signal processing, digital modulation and demodulation, and functions such as forward error correction and equalization soft decision. The data transmission radio is suitable for an external environment in which communication points in the substation are relatively dispersed and a certain amount of electromagnetic field interference exists, and can acquire wireless data in the small communication base station to the wireless data acquisition module 302.

The small communication base station collects data of each RTU and acquires the data to the data transmission radio.

The RTU is located in the substation switchyard, and mainly uploads state information, such as terminal box door switches in the substation switchyard, to the small communication base station in a 0/1 manner, uploads data in the oil temperature gauge and the winding temperature gauge in the substation to the small communication base station as a 4-20 mA analog quantity, and uploads a normal value, an alarm value, and a lockout value of the SF6 density relay in the switchyard to the small communication base station in a 1/0/−1 manner.

The data conversion module 400 is connected to the data snapshot module 200, and converts relay protection external operation information data in a specific format, which is snapshotted by the data snapshot module 200 during the time period from T1−T2 to T1+T2, into conventional relay protection external operation information data and compresses the conventional relay protection external operation information data. The data conversion module 400 is connected to the real-time data summoning module 1000, and converts real-time relay protection external operation information data in the specific format into conventional relay protection external operation information data. The data conversion module 400 is connected to the data storage module 500, and stores relay protection external operation information during the time period from T1−T2 to T1+T2 in the data storage module 500. The data conversion module 400 is connected to the real-time data analysis module 900, and transmits real-time relay protection external operation information data converted into a conventional format to the real-time data analysis module 900. A function of the wireless data conversion module is to convert data in the specific format into conventional data according to conversion rules. The conversion rules are as follows: for a cabinet door state, specific format 0 is converted into closed, and specific format 1 is converted into open; for an SF6 density relay, specific format 1 is converted into normal SF6 gas pressure, specific format 0 is converted into an SF6 gas pressure alarm, and specific format −1 is converted into an SF6 gas pressure lockout; for an actual position of a circuit breaker, specific format 1 is converted into a closed position, and specific format 0 is converted into an open position; for an energy storage stroke of a circuit breaker spring, specific format 1 is converted into stored energy, and specific format 0 is converted into unstored energy; for a temperature and humidity state, specific format 1 is converted into normal, and specific format 0 is converted into abnormal; and for an oil temperature gauge and a winding temperature gauge, specific format 4 mA<I1<20 mA is converted into temperature, expressed as:

$$t = {t}_{l} \times ( {l}_{1} \div 16 ) ;$$

where t₁ is a maximum temperature range of the oil temperature gauge or the winding temperature gauge, and l₁ is an analog current transmitted by the oil temperature gauge or the winding temperature gauge through the RTU. Videos larger than 10 MB, and images larger than 2 MB, are compressed. The compression uses the MPEG-4 standard, and data is compressed and transmitted through frame reconstruction technology, so as to maintain good image quality while reducing data volume. The MPEG-4 standard is not only directed to video and audio coding at a certain bit rate, but also focuses more on interactivity and flexibility of a multimedia system. In addition, bandwidth occupied by the MPEG-4 standard is adjustable and is proportional to image definition; generally, bandwidth of about several hundred kilobytes is sufficient to clearly obtain relay protection external operation information from a video. By converting data in the specific format and compressing video and image data, network bandwidth occupation can be reduced while satisfying relay protection external operation information transmission and recognition requirements, thereby helping to reduce network bandwidth occupation of the system during data transmission.

The data storage module 500 is connected to the real-time data analysis module 900, and receives and stores data whose analysis result is abnormal; the data storage module 500 is connected to the fault analysis module 600, and sends relay protection external operation information data during the time period from T1−T2 to T1+T2 to the fault analysis module 600 for fault analysis.

In an embodiment, the fault analysis module 600 analyzes relay protection external operation information data during the time period from T1−T2 to T1+T2 according to preset rules. The preset rules are judgment logic based on an equipment state, human behavior, and an environmental factor. Data during the time period from T1−T2 to T1+T2 is decoded and analyzed to determine position information of a circuit breaker, where a closed position is a normal state; determine energy storage spring information of the circuit breaker, where stored energy is a normal state; determine state information of an SF6 density relay of the circuit breaker, where normal SF6 gas pressure is a normal state; and check state information of cabinet doors of a terminal box, a mechanism box, and a protection panel, where closed is a normal state. When all equipment information is determined to be normal, tripping is determined to be caused by a non-equipment reason; when abnormal equipment information exists, equipment is determined to have an abnormality before a fault.

When the equipment has the abnormality before the fault, the abnormality of the equipment is checked through a daily monitoring video in the station, and video recognition is performed to determine whether a person appears. If a person appears, human behavior is determined; if no person appears in the video, an environment is determined. When tripping is caused by the non-equipment reason, or when the equipment has the abnormality before the fault and a person is recognized, an on-site operation video monitoring system is used to determine whether a person contacting tripped equipment exists. If a person contacts the equipment, video recognition is used to determine whether misoperation or accidental contact exists. If misoperation or accidental contact exists, the tripping is deemed to be caused by human behavior, and the fault analysis module 600 sends information indicating that a person worked on the tripped equipment before the equipment tripped and sends work content. If no misoperation or accidental contact exists, occurrence of fault tripping caused by a human factor is excluded. When tripping is caused by the non-equipment reason, or when the equipment has the abnormality before the fault and no person is recognized, environmental factor analysis is performed. A resistance to ground of a protection power supply branch of the tripped equipment is determined, and a resistance to ground of a control power supply branch and a resistance to ground of a direct current system are detected. If the resistance to ground is less than 20 kΩ, direct current grounding is determined to exist, and the direct current system is determined to have an abnormality before the fault. If the resistance to ground is greater than 20 kΩ, direct current grounding is determined not to exist, and occurrence of the fault is determined not to be caused by an equipment operating environment.

By collecting, decoding, and analyzing relay protection external operation information within a preset time period before and after a fault occurs, and combining video information to assist in determining an equipment state, human behavior, and an environmental factor, support can be provided for fault analysis by dispatchers and relevant personnel, thereby helping to reduce fault judgment deviations caused by insufficient information.

The report generation module 700 is connected to the real-time data analysis module 900 and obtains analysis data from the real-time data analysis module 900. The report generation module 700 generates an analysis report according to a time selected by a dispatcher.

The real-time data analysis module 900 is connected to the report generation module 700 and the alarm signaling module 800. The real-time data analysis module 900 sends analyzed abnormal state-change information to the report generation module 700 to generate an analysis report, and the real-time data analysis module 900 simultaneously sends the analyzed abnormal state-change information to the alarm signaling module 800 to prompt a dispatcher that an abnormal state change exists in the relay protection external operation information.

The real-time data analysis module 900 is connected to the data conversion module 400, receives converted conventional relay protection external operation information data, and performs analysis according to a principle of combining abnormal state-change information with images. When a state of relay protection associated equipment changes abnormally, the real-time data analysis module 900 determines, in combination with video information of a corresponding substation, whether corresponding work exists and whether a working range is expanded. The real-time data summoning module 1000 is connected to the data acquisition module 300, and receives wired transmission data, wireless transmission data, and video image data transmitted by the data acquisition module 300. The real-time data summoning module 1000 is connected to the data conversion module 400, and decodes the wireless transmission data transmitted by the data acquisition module 300 and compresses the video image data. Through real-time summoning, inspection, and analysis of daily relay protection external operation information, and by combining abnormal state-change information and video image information for comprehensive determination, the system can supplement existing remote inspection of relay protection and help promptly discover an abnormal condition affecting an operating state of a relay protection device.

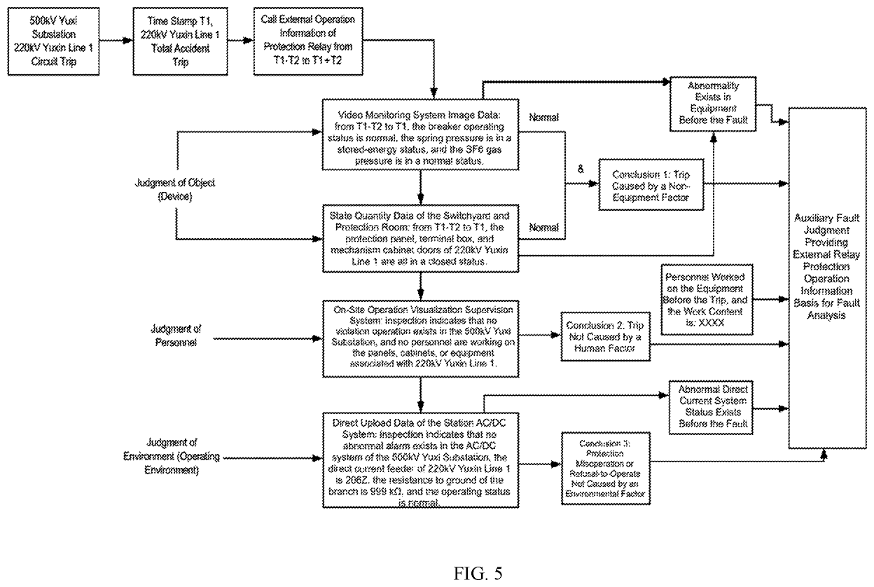

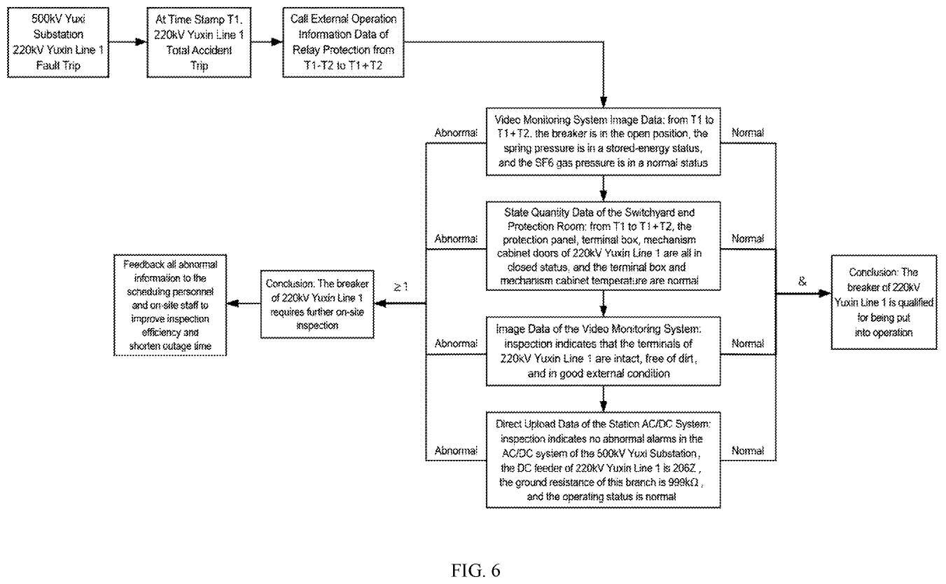

Referring to FIG. 5 to FIG. 6, an embodiment of the present application provides an intelligent management system for relay protection external operation information. To verify effects of the present application, scientific demonstration is performed through economic benefit calculation and simulation experiment. Table 1 shows acquisition and analysis results of relay protection external operation information during a time period before and after a fault in an example scenario.

TABLE 1
Fault Relay Protection External Operation Information Upload Table for 220 kV XX Line

| | |
|---|---|
| Relay protection external operation | Relay protection external operation |
| information before the accident | information after the accident |

Accident time T1: 2023.06.28 14:40:12.283ms T2:24s

| Extraction time: 2023.06.28 | | | Extraction time: 2023.06.28 | | |
|---|---|---|---|---|---|
| From 14:39:48.283ms to 14:40:12.283ms | | | From 14:40:12.283ms to 14:40:36.283ms | | |
| | Uploaded | Conventional | | Uploaded | Conventional |
| Data name | value | value | Data name | value | value |
| 220 kV XX line | 0 | closed | 220 kV XX line | 0 | closed |
| circuit breaker | | | circuit breaker | | |
| terminal box cabinet | | | terminal box | | |
| door | | | cabinet door | | |
| 220 kV XX line | 0 | normal | 220 kV XX line | 0 | normal |
| circuit breaker | | | circuit breaker | | |
| terminal box | | | terminal box | | |
| temperature and | | | temperature and | | |
| humidity | | | humidity | | |
| 220 kV XX line | 0 | closed | 220 kV XX line | 0 | closed |
| circuit breaker | | | circuit breaker | | |
| mechanism box | | | mechanism box | | |
| cabinet door | | | cabinet door | | |
| 220 kV XX line | 0 | normal | 220 kV XX line | 0 | normal |
| circuit breaker | | | circuit breaker | | |
| mechanism box | | | mechanism box | | |
| temperature and | | | temperature and | | |
| humidity | | | humidity | | |
| 220 kV XX line | 1 | stored energy | 220 kV XX line | 1 | stored energy |
| circuit breaker | | | circuit breaker | | |
| energy storage | | | energy storage | | |
| spring state | | | spring state | | |
| Actual position of | 1 | closed | Actual position | 0 | open position |
| 220 kV XX line | | position | of 220 kV XX | | |
| circuit breaker | | | line circuit | | |
| | | | breaker | | |
| 220 kV XX line | 1 | normal SF | 220 kV XX line | 1 | normal SF |
| circuit breaker SF6 | | gas pressure | circuit breaker | | gas pressure |
| density relay | | | SF6 density | | |
| | | | relay | | |
| 220 kV XX line | 0 | closed | 220 kV XX line | 0 | closed |
| main-I protection | | | main-I | | |
| panel cabinet door | | | protection panel | | |
| state | | | cabinet door | | |
| | | | state | | |
| 220 kV XX line | 0 | closed | 220 kV XX line | 0 | closed |
| main-II protection | | | main-II | | |
| panel cabinet door | | | protection panel | | |
| state | | | cabinet door | | |
| | | | state | | |

| | | | |
|---|---|---|---|
| Positive-to-ground | 10 kΩ | To-ground | 999.99 kΩ |
| resistance of control | | resistance of | |
| bus of DC system of | | control bus of | |
| 500 kV XX | | DC system of | |
| substation | | 500 kV XX | |
| | | substation | |
| Positive-to-ground | 10 kΩ | To-ground | 999.99 kΩ |
| resistance of closing | | resistance of | |
| bus of DC system of | | closing bus of | |
| 500 kV XX substation | | DC system of | |
| | | 500 kV XX substation | |
| Positive-to-ground | 999.99 kΩ | To-ground | 999.99 kΩ |
| resistance of power | | resistance of | |
| supply branch of | | power supply | |
| main-I protection | | branch of main-I | |
| device of 220 kV | | protection | |
| XX line | | device of 220 | |
| | | kV XX line | |
| Positive-to-ground | 999.99 kΩ | To-ground | 999.99 kΩ |
| resistance of power | | resistance of | |
| supply branch of | | power supply | |
| main-II protection | | branch of main- | |
| device of 220 kV | | II protection | |
| XX line | | device of 220 | |
| | | kV XX line | |
| Positive-to-ground | 10 kΩ | To-ground | 999.99 kΩ |
| resistance of first | | resistance of | |
| group control power | | first | |
| supply branch of | | group | |
| 220 kV XX line | | control power | |
| circuit breaker | | supply branch of | |
| | | 220 kV XX line | |
| | | circuit breaker | |
| Positive-to-ground | 10 kΩ | To-ground | 999.99 kΩ |
| resistance of second | | resistance of | |
| group control power | | second group | |
| supply branch of | | control power | |
| 220 kV XX line | | supply branch of | |
| circuit breaker | | 220 kV XX line | |
| | | circuit breaker | |

| | | | |
|---|---|---|---|
| Extracted on-site operation video: live-line | — | — | — |
| operation video of 220 kV XX line at 500 kV XX | | | |
| substation.MOV (size 103 MB) | | | |
| Extracted in-station monitoring video: in-station | — | — | — |
| monitoring video of 500 kV XX | | | |
| substation.MOV (size 971 MB) | | | |

| | |
|---|---|
| Conclusion: Before the fault, the positive-to- | Conclusion: The equipment operates |
| ground resistances of the first and second group | normally after the fault and has operating |
| control circuits of the 220 kV XX line are both | conditions. |
| 10 kΩ, and the positive-to-ground resistance of | The above information can provide reference |
| the control bus of the DC system is 10 kΩ, all of | information after the accident for the |
| which are lower than the 20 kΩ threshold. This | dispatcher, to assist in determining an |
| indicates that DC grounding exists before the | equipment state and whether power |
| fault, thereby causing abnormalities in the first | restoration conditions are met. |
| and second group control circuits of the 220 kV | |
| XX line circuit breaker. In combination with the | |
| video system, it can be known that live-line | |
| operation on the 220 kV XX line at the 500 kV | |
| XX substation is being carried out during the DC | |
| grounding, and the workers do not correctly | |
| carry out this work, causing the DC system | |
| grounding fault to occur and affecting an | |
| operating state of the circuit breaker control | |
| circuit. | |
| The above information can provide reference | |
| information before the accident for the | |
| dispatcher, to assist in making a clearer judgment | |
| on the fault. | |

In an embodiment of the present application, a method for intelligent management of relay protection external operation information includes: when a fault occurs at time T1, the input module 100 receives a whole-station accident general input. The data snapshot module 200 snapshots relay protection external operation information data acquired by the data acquisition module 300 during a time period from T1−T2 to T1+T2. The data acquisition module 300 simultaneously transmits real-time operation data of equipment to the real-time data summoning module 1000. The data snapshot module 200 and the real-time data summoning module 1000 send data to the data conversion module 400. The data conversion module 400 converts the data in the specific format into conventional data according to conversion rules, and sends the conventional data to the data storage module 500 and the real-time data analysis module 900. The data storage module 500 receives and stores data whose analysis result is abnormal and the relay protection external operation information data during the time period from T1−T2 to T1+T2, and after storage is completed, forwards the relay protection external operation information data during the time period from T1−T2 to T1+T2 to the fault analysis module 600 for fault cause analysis. The real-time data analysis module 900 sends abnormal state-change information to the report generation module 700 and the alarm signaling module 800 to generate a fault report and send the fault report to a dispatcher, and simultaneously issues a fault alarm. Through coordinated cooperation among the above modules, relay protection external operation information can be processed in a linked manner among acquisition, conversion, storage, analysis, report generation, and alarm output, thereby helping to improve collaborative processing capability of the system.

The above embodiments are only used to illustrate the technical solutions of the present application, and are not intended to limit the present application. It should be understood that, without departing from the technical concept of the present application, those skilled in the art may make various modifications, substitutions, or variations to the above embodiments, and these modifications, substitutions, or variations shall fall within the scope defined by the claims appended to the present application.

1. An intelligent management system for relay protection external operation information, comprising: an input module, a data snapshot module, a data acquisition module, a data conversion module, a data storage module, a fault analysis module, a report generation module, an alarm signaling module, a real-time data analysis module, and a real-time data summoning module, wherein:
the input module is connected to the data snapshot module, and in response to receiving a whole-station accident general input, the input module sends a time stamp signal T1 to the data snapshot module;
the data snapshot module snapshots relay protection external operation information data acquired by the data acquisition module during a time period from T1−T2 to T1+T2;
wherein, T2 represents a data snapshot delay, T2 is set to Tmax, and Tmax is a longest setting time of a protection action in a station;
the data acquisition module acquires real-time relay protection external operation information;
the data conversion module faithfully transmits preset types of data, compresses and transmits other types of data, and converts relay protection external operation information in a specific format into conventional information;
the data storage module receives and stores data;
the fault analysis module analyzes and classifies faults according to preset rules to implement intelligent data processing and analysis;
the report generation module generates a report according to a real-time data analysis result;
the alarm signaling module sends an abnormal result in real-time data analysis to a dispatcher and issues an alarm;
the real-time data analysis module analyzes an abnormal state change in the real-time relay protection external operation information; and
the real-time data summoning module summons the real-time relay protection external operation information.

2. The intelligent management system for relay protection external operation information according to claim 1, wherein:
the data acquisition module is connected to the data snapshot module, and the data acquisition module provides the data snapshot module with real-time relay protection external operation information data;
the data acquisition module comprises a wired data acquisition module, a wireless data acquisition module, a video image data calling module, and an analog quantity acquisition module;
the wired data acquisition module acquires relay protection external operation information transmitted in the station through a 61850 communication protocol, comprising state data of a station service direct current system and an alternating current system;
the wireless data acquisition module acquires, in a switchyard, relay protection external operation information not directly transmissible in a wired manner, the relay protection external operation information comprising state data of terminal box cabinet doors, oil temperature gauges, winding temperature gauges, SF6 density relays, actual positions of circuit breakers, actual positions of energy storage springs, and temperature and humidity states in terminal boxes and mechanism boxes;
the video image data calling module is connected to an on-site operation visual supervision system and a station video image monitoring system, and calls on-site operation videos and daily video image monitoring videos in the station; and
the analog quantity acquisition module is configured to acquire an operating current and a ground current in the station.

3. The intelligent management system for relay protection external operation information according to claim 2, wherein:
the data conversion module is connected to the data snapshot module, converts relay protection external operation information data in the specific format into conventional relay protection external operation information data, and compresses the conventional relay protection external operation information data, and the relay protection external operation information data in the specific format is snapshotted by the data snapshot module during the time period from T1−T2 to T1+T2;
the data conversion module is connected to the real-time data summoning module, and converts real-time relay protection external operation information data in the specific format into conventional relay protection external operation information data;
the data conversion module is connected to the data storage module, and stores relay protection external operation information during the time period from T1−T2 to T1+T2 in the data storage module;
the data conversion module is connected to the real-time data analysis module, and transmits real-time relay protection external operation information data converted into a conventional format to the real-time data analysis module;
the data conversion module comprises a wireless data conversion module and a video image data compression module;
the wireless data conversion module is configured to convert data in the specific format into conventional data according to conversion rules;
the video image data compression module is configured to compress videos and images; and
the conversion rules comprise: for a cabinet door state, specific format 0 is converted into closed, and specific format 1 is converted into open; for an SF6 density relay, specific format 1 is converted into normal SF6 gas pressure, specific format 0 is converted into an SF6 gas pressure alarm, and specific format −1 is converted into an SF6 gas pressure lockout; for an actual position of a circuit breaker, specific format 1 is converted into a closed position, and specific format 0 is converted into an open position; for an energy storage stroke of a circuit breaker spring, specific format 1 is converted into stored energy, and specific format 0 is converted into unstored energy; for a temperature and humidity state, specific format 1 is converted into normal, and specific format 0 is converted into abnormal; and for an oil temperature gauge and a winding temperature gauge, specific format 4 mA<I1<20 mA is converted into temperature, expressed as:
$$t = {t}_{l} \times ( {l}_{1} \div 16 ) ;$$
wherein t₁ is a maximum temperature range of the oil temperature gauge or the winding temperature gauge, and l₁ is an analog current transmitted by the oil temperature gauge or the winding temperature gauge through a remote terminal unit (RTU).

4. The intelligent management system for relay protection external operation information according to claim 3, wherein:
the data storage module is connected to the real-time data analysis module, and receives and stores data having an abnormal analysis result; and
the data storage module is connected to the fault analysis module, and sends the relay protection external operation information data during the time period from T1−T2 to T1+T2 to the fault analysis module for fault analysis.

5. The intelligent management system for relay protection external operation information according to claim 4, wherein:
the fault analysis module is configured to analyze relay protection external operation information data during the time period from T1−T2 to T1+T2, decode and analyze data during the time period from T1−T2 to T1+T2, determine position information of a circuit breaker, wherein a closed position is a normal state, determine energy storage spring information of the circuit breaker, wherein stored energy is a normal state, determine state information of an SF6 density relay of the circuit breaker, wherein normal SF6 gas pressure is a normal state, check state information of cabinet doors of a terminal box, a mechanism box, and a protection panel, wherein closed is a normal state, determine tripping to be caused by a non-equipment reason in response to determining all equipment information to be normal, and determine equipment to have an abnormality before a fault in response to abnormal equipment information existing;
in response to equipment having the abnormality before the fault, the abnormality of the equipment is checked through a daily monitoring video in the station, video recognition is performed to determine whether a person appears, human behavior is determined in response to a person appearing, and an environment is determined in response to no person appearing in the video;
in response to tripping being caused by the non-equipment reason, or in response to the equipment having the abnormality before the fault and a person being recognized, a video in an on-site operation video monitoring system is used to determine whether a person has contacted tripped equipment, in response to a person contacting the equipment, video recognition is used to determine whether misoperation or accidental contact exists, in response to misoperation or accidental contact existing, the tripping is deemed to be caused by human behavior, the fault analysis module sends information indicating a person worked on the tripped equipment before the equipment tripped and sends work content, and in response to neither misoperation nor accidental contact existing, occurrence of fault tripping caused by a human factor is excluded; and
in response to tripping being caused by the non-equipment reason, or in response to the equipment having the abnormality before the fault and no person being recognized, environmental factor analysis is performed, a resistance to ground of a protection power supply branch of tripped equipment is determined, a resistance to ground of a control power supply branch and a resistance to ground of a direct current system are detected, in response to the resistance to ground being less than 20 kΩ, direct current grounding is determined to exist and the direct current system is determined to have an abnormality before the fault, and in response to the resistance to ground being greater than 20 kΩ, direct current grounding is determined not to exist and occurrence of the fault is determined not to be caused by an equipment operating environment.

6. The intelligent management system for relay protection external operation information according to claim 5, wherein:
the report generation module is connected to the real-time data analysis module and obtains analysis data from the real-time data analysis module; and
the report generation module generates an analysis report according to a time selected by the dispatcher.

7. The intelligent management system for relay protection external operation information according to claim 6, wherein:
the real-time data analysis module is connected to the report generation module and the alarm signaling module, the real-time data analysis module sends analyzed abnormal state-change information to the report generation module to generate an analysis report, and the real-time data analysis module simultaneously sends the analyzed abnormal state-change information to the alarm signaling module to prompt the dispatcher of an abnormal state change in the relay protection external operation information;
the real-time data analysis module is connected to the data conversion module, receives converted conventional relay protection external operation information data, and performs analysis according to a principle of combining abnormal state-change information with images, and in response to a state of relay protection associated equipment changing abnormally, determines, in combination with video information of a corresponding substation, whether corresponding work exists and whether a working range is expanded;
the real-time data summoning module is connected to the data acquisition module, and receives wired transmission data, wireless transmission data, and video image data transmitted by the data acquisition module; and
the real-time data summoning module is connected to the data conversion module, and decodes the wireless transmission data transmitted by the data acquisition module and compresses the video image data.

8. A method for intelligent management of relay protection external operation information, applied to the intelligent management system for relay protection external operation information according to claim 1, comprising:
in response to a fault occurring at time T1, receiving, by the input module, a whole-station accident general input;
snapshotting, by the data snapshot module, relay protection external operation information data acquired by the data acquisition module during the time period from T1−T2 to T1+T2;
simultaneously transmitting, by the data acquisition module, real-time operation data of equipment to the real-time data summoning module;
sending, by the data snapshot module and the real-time data summoning module, data to the data conversion module;
converting, by the data conversion module, data in a specific format into conventional data according to conversion rules, and sending the conventional data to the data storage module and the real-time data analysis module;
receiving and storing, by the data storage module, data having an abnormal analysis result and the relay protection external operation information data during the time period from T1−T2 to T1+T2, and after storage is completed, forwarding the relay protection external operation information data during the time period from T1−T2 to T1+T2 to the fault analysis module for fault cause analysis; and
sending, by the real-time data analysis module, abnormal state-change information to the report generation module and the alarm signaling module, generating a fault report and sending the fault report to the dispatcher, and issuing a fault alarm.
